(19) United States
(12) Patent Application Publication
(10) Pub. No.: US 2018/0165706 A1
(43) Pub. Date: Jun. 14, 2018

(54) SYSTEMS AND METHODS FOR IMPROVING SOCIAL MEDIA ADVERTISING EFFICIENCY

(71) Applicant: Sprinklr, Inc., New York, NY (US)

(72) Inventors: Xin FENG, New York, NY (US); Ragy THOMAS, New York, NY (US); Murali SWAMINATHAN, New York, NY (US)

(73) Assignee: Sprinklr, Inc., New York, NY (US)

(21) Appl. No.: 15/377,899

(22) Filed: Dec. 13, 2016

(51) Int. Cl. G06Q 30/02

(52) U.S. Cl. CPC G06Q 30/0244; G06Q 50/01; G06Q 30/0277

(57) ABSTRACT

Systems and methods that enable enhanced social media advertising efficiency using mixed model equations to process advertisement data. A model is described that calculates enhanced advertisement data based on calculations using and re-using variables to isolate keys for effective advertisement.

### BACKGROUND

### 1. Field

The present disclosure relates generally to systems and methods for improving advertising efficiency based on intangible inputs including those from social media that are currently not considered for advertisement optimization.

### 2. Related Art

Advertisers worldwide spent more than $545 billion on paid media in 2014 and the number grew tremendously in 2015 and is expected to continue to grow. Advertisers demand advanced technology along with complicated mathematical modeling to conduct targeted advertisement and increase efficiency. There are many factors affecting advertising efficiency and many newer factors are discovered or accumulated over time. Some of the factors are defined as fixed effects and others defined as random effects in statistical worlds which are typically due to intangible factors. The contribution magnitude of each such factor can be mathematically estimated if sufficient data exists.

For digital advertising, an advertisement (ad) is almost always one or a group of banners which are usually one graphic image or set of animated images of a designated pixel size and byte size limit. One impression is made as soon as any ad appears on targeted media. Digital ad banners are usually associated with a clickable underlying link. One click through occurs if a targeted user clicks the banner ad and is redirected to another web page. One conversion is realized if a targeted user conducts further activity, such as purchasing a product, registering to a sponsored site, leaving feedback and publishing ideas etc. The conversion measures two way communications and it requires recorded traceable user activities. Thus:
impression=count of advertising unit appearing on target media
clickthrough=count on the sponsoring site as a result of an ad click
conversion=count on the sponsoring site, when further activity is recorded.

The clickthrough rate is the percentage of ad views that results in clickthroughs and it is currently considered the most popular advertisement efficiency measurement. Although pure ad views may bring beneficial effects to brand value, objective advertisement effectiveness is very hard to measure. The clickthrough rate depends heavily on a number of factors, such as the campaign objectives, how enticing the banner message is, how explicit the message is, audience/message targeting matching, how new the banner is, how often it is displayed to the same user, to capture his attention, and so forth.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Ad efficiency also typically relates to tangible demographics, which is data about the size and characteristics of a population or audiences. Today, these demographics include only traditional concrete factors like gender, age, income, ethic, religion, region, education, work history, family size, children etc. There are many more components of demographics that are the newly discovered intangible factors, like individuals search history, purchase history, work interests, other interests, social activity, social influence, friend circle, any intangible information received from social media, user sentiment at any instant, mood, personality, most admired influencers, etc. All these intangible factors in demographics, if they can be included in the ad efficiency matrix, can be used for target advertising to increase the ad efficiency considerably. Information received from Social media can be any information received or derived from any web site where social interactions take place. This can include any posting on Facebook, Twitter, Google, Snapchat, Instagram etc. What is proposed is a way to include these new demographic factors in modeling for improvement of ad efficiency such that the ads presented are optimum for the target demographic. Embodiments of the invention relate to a system and method for automatically selecting the most efficiency strategy for ad content development and ad placement.

In accordance with one aspect of the invention, a system for converting available tangible and intangible parameters into an efficiency and placement strategy of an advertising object is disclosed that includes: a processor; a memory containing machine readable medium comprising machine executable code having stored thereon instructions for operating the system, wherein the processor is coupled to the memory, the memory further containing available parameters, wherein the available parameters comprise tangible parameters and intangible parameters and wherein the available parameters impact an efficiency of the advertising object and optimum placement of the advertising object; wherein the system is configured to execute the machine executable code to cause the control system to: aggregate impressions, clickthrough rates and conversion rates of a placed advertising object to generate an initial result for an ad efficiency; using the initial result, solve a mixed model equation with the available parameters, each with an assigned weightage, as coefficients in an iterative fashion by adjusting the assigned weightage of the available parameters; evaluate fitness of each iteration to calculate an estimate of a fitness of each of the available parameters and the improvement in efficiency of the advertising object and its placement when using the available parameters; optimize the advertising object and a strategy for placement of the advertising object; and implement the optimized advertising object and placement strategy.

The intangible parameters may be extracted from social media.

A genetic algorithm may be used to optimize the advertising object and the strategy for placement of the advertising object.

The genetic algorithm may run a search from a selected population of respondents at each iteration, selecting and adding or subtracting from a pool of the population until a termination criterion for selection is met.

The use of the genetic algorithm may include determining one or more selected from the group consisting of individual representation in the population, a selection function which provides a consolidation of the characteristics of the focus population, genetic operators that make up interrelationship functions that are interrelated secondary functions based on functional relationships between the parameters, estimation termination criteria as the values of the genetic algorithm converge, and an evaluation function for the advertising object efficiency measurement.

A plurality of mixed model equations may be solved.

The memory may further comprise historic data and the system may use the historic data as a starting point for the available parameters.

According to another aspect of the invention, a computerized method is disclosed that includes aggregating impressions, clickthrough rates and conversion rates of a placed advertising object; solving a mixed model equation in an iterative fashion by adjusting a weightage assigned to available parameters, wherein the available parameters comprise tangible parameters and intangible parameters; evaluating fitness of each iteration to calculate an estimate of a fitness of each of the available parameters and efficiency of the advertising object and its placement when using the available parameters; optimizing an advertising object and a strategy for placement of the advertising object; and implementing the optimized advertising object and placement strategy.

The method may further include extracting the intangible parameters from social media.

Genetic algorithms may be used to optimize the advertising object and the strategy for placement of the advertising object. The genetic algorithm may run a search from a selected population of respondents at each iteration, selecting and adding or subtracting from a pool of the population until a termination criterion for selection is met.

The use of the genetic algorithm may include determining one or more selected from the group consisting of individual representation in the population, a selection function which provides a consolidation of the characteristics of the focus population, genetic operators that make up interrelationship functions that are interrelated secondary functions based on functional relationships between the parameters, estimation termination criteria as the values of the genetic algorithm converge, and an evaluation function for the advertising object efficiency measurement.

Solving the mixed model equation in an iterative fashion may further include solving a plurality of mixed model equations.

The may further include constructing the mixed model equation.

The method of claim 8, further comprising using historic data as a starting point for the available parameters.

In accordance with a further aspect of the invention, a computerized advertisement optimization system is disclosed that includes a computer server including: an advertisement assessment tool to generate an initial assessment of efficiency of an advertisement; a mixed model equation module to solve a mixed model equation of the advertisement efficiency and placement strategy using weighted tangible parameters for fixed effects and weighted intangible parameters for random effects and provide an estimate of the advertisement efficiency and ad placement strategy; an adjustment module to adjust the weightage assigned to at least one chosen parameter from the tangible parameters and intangible parameters, in an iterative fashion to optimize the efficiency and placement strategy; and a fitness evaluation module to evaluate the fitness of the at least one chosen parameter for iterative adjustment of weightage and change the at least one chosen parameter based on their impact on the result of the solution of the mixed model equation; and an optimized advertisement assessment tool to check and extract the estimate of result, from the plurality of results of the iterative solution of the mixed model equation, that provide the optimized advertisement and strategy for placement of the advertisement.

The system may further include a data store configured to store information relating to the mixed model equations that contain the experience-based weighted intangible demographic factors.

The system may further include an advertisement assessment tool to assess typical advertisement efficiency of an advertisement without optimization using intangible demographics from social media.

The system further include an optimized advertisement assessment tool to select a most efficiency strategy for advertisement object placement based on the result of the iterative processing of data through the mixed model equation module with the weightage step adjusted for the intangible demographic parameters at each iteration using the value adjustment module, and the estimates of the fitness of each individual intangible demographic parameter and the efficiency data after each iteration in the evaluation module and extract the optimized advertisement object and placement characteristics from the iterated value.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a schematic diagram of a social media advertising system according to an embodiment of the invention.

FIG. 2 is an exemplary flow chart of a method for enhancing the advertisements and delivering them to the target demographic according to an embodiment of the invention.

FIG. 3 is an exemplary flow chart of the inclusion of intangible demographic factors, typically extracted from social media measurements, into mixed model equations, for ad efficiency improvement according to an embodiment of the invention.

### DETAILED DESCRIPTION

Embodiments of the invention relate to a system and method to improve advertising efficiency using intangible demographic factors, typically extracted from social media. In one embodiment, a method is detailed that employs a mixed model equation to estimate parameters and applies arbitrary weights, that are iteratively adjusted for optimum performance, on individual efficiency measurements to form an object function. The method then uses genetic algorithms to select the most efficient strategy for ad optimization and placement for exposure to the target demographic and hence optimizing the ad efficiency. A model is described that calculates enhanced advertisement data based on using and re-using previously optimized variables to isolate keys for effective advertisement. For example, direct and indirect variables are calculated as indicators of both primary and secondary factors when making calculations. Examples of indirect factors include usage of group factors, such as genetic type (gender, age, race etc.). In order to do this, mathematical factors as well as genetic factors are used to help figure out and predict user clicks on advertisement and accordingly, to optimize advertisements for the highest return.

In addition, embodiments of the present invention may include fitness values, which are based on estimations that provide the impact of isolated specific factors. These are estimated and then validated using comparative effects of the advertisement efficiency with and without the use of these factors. For example, estimation may be used on specific parameters of the advertisement impact and also on aggregate data collected. A parameter estimation and aggregation algorithm is used, based on experience and previous definitions, to help map these on actual advertisement efficiency results to determine data accuracy. These maps therefore include potential data that are indicators to help achieve optimized performance of advertisement generated and presented.

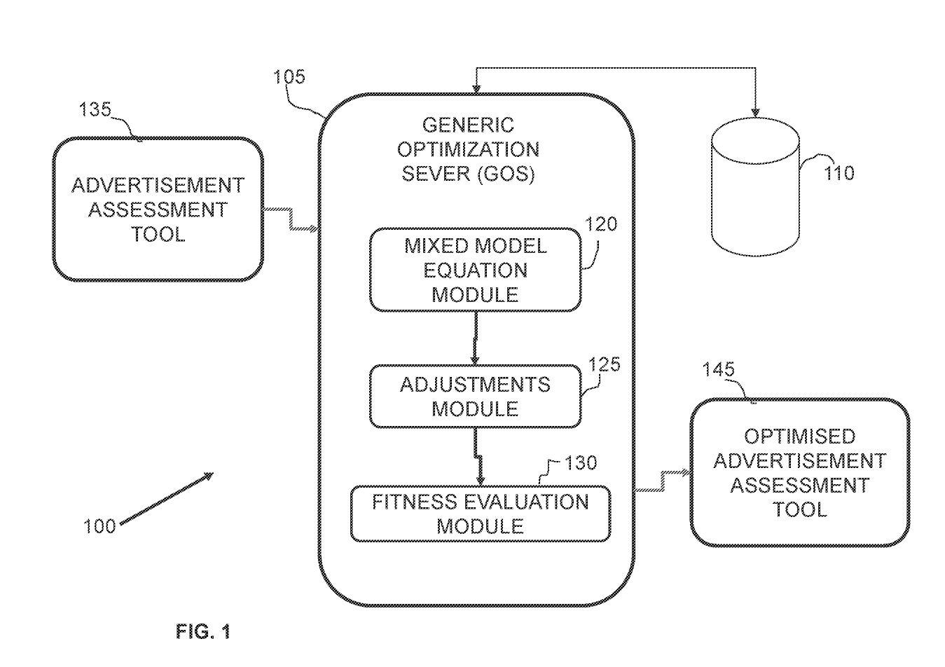

FIG. 1 shows a schematic diagram of an advertisement optimization system 100. As shown in FIG. 1, the system 100 includes a genetic optimization server (GOS) 105 which has the processing capability to run the programs needed to optimize an advertisement, a GOS database (GOS DB) 110, an advertisement assessment tool 135, and an optimized advertisement assessment tool 145. The GOS 105 may further include a mixed model equation module 120, an adjustment module 125, and a fitness evaluation module 130.

Advertisement assessment tool 135 is used to assess the typical advertisement efficiency of an advertisement without the optimization using intangible demographics from social media. For example, by calculating clickthrough rates and conversion rates for typical online advertisements.

GOS 105, generally in communication with GOS DB 110, deploys general mixed model equations, based on an assumption that objective functions may yield improved results of click through and conversion rates for the ads with inclusion of available intangible demographic factors. GOS DB 110 stores information relating to the mixed model equations that contain the experience based weighted intangible demographic factors. Since advertisement efficiency is usually measured by click through rate or conversion rates, both these rates are converted to continuous numeric variables with value ranges from 0.0 to 1.0 for each advertisement, where a higher efficiency value advertisement will bring higher economic benefit to the user. There are two types of information stored in object database GOS DB 110. The first type of information is related to Ad characteristics and Ad placement. This type of information is related to the advertisement or advertising object (Ad) itself and includes, for example: Ad creation agent, Ad type (Image, Video, Text banner, etc.), Ad content, Ad owner information, Ad distribution agent, Ad placement time, Ad placement channel, Ad target demographic information (age, gender, region, education, shopping history, interests, etc.), and the like. The second type of information is what is used for algorithm optimization. It may include initial optimization parameters used which include the intangible demographic factors, extracted typically from social media, initial weightage values assigned to the factors, step value for iteration of the weightage, fitness value from previous Ad iterations, intermediate search result, etc. These include the Ad placement efficiency values that are collected and recorded daily into the database. The estimated and collected efficiency values and all corresponding Ad placement information are used for future modeling for optimizing Ads and Ad placement to maximize Ad efficiency. That is, any estimated or available Ad efficiency value is used as an initial dependent variable and all Ad placement information factors are used as independent variables in the mixed model equation to estimate new parameters. New parameters are then fitted back into the genetic algorithm for further optimization, such that a new set of Ad placement information are calculated and used for the next cycle of the Ad efficiency estimation and ad efficiency evaluation. Intermediate values of data or information from the iteration are also saved in the GOS DB 110 and used in subsequent iterative data analysis. Storing intermediate data values into the database enable speedup of subsequent data retrieval for analysis and data management.

Optimized advertisement assessment tool 145 enables selection of the most efficiency strategy for ad implementation and placement, based on the results of the iterative processing of data within the mixed model equation module 120 with weightage step adjusted for the intangible demographic parameters at each iteration using the value adjustment module 125, and estimating the fitness of each individual intangible demographic parameter and its interaction and impact on the estimate of the Ad efficiency data returned after each iteration through the adjustment module using the evaluation module 130. The optimized advertisement assessment tool 145 is then able to extract the optimized Ad and placement characteristics from the iterated value of overall fitness characteristics to enable optimum placement. The results from the placement are collected and made available to advertisement assessment tool 135, which then form the next basis for estimations of improvement and also provides a realistic and real world feedback assessment of the effectiveness of the optimization strategy.

In short the operation of the advertisement optimization system 100 of FIG. 1 can be summarized as:

The genetic optimization server 105 extracts and stores in the connected data base 110 the demographic parameters, both tangible and intangible, that impact the advertisement and its placement strategy. The data base 110 also holds the mixed model equation format.

The advertisement assessment tool 135 evaluates an advertisement using the standard efficiency matrix that does not take into account the impact of the random variables, that are the intangible demographic parameters. This initial measure of efficiency forms the starting value for efficiency of that advertisement for any genetic equation.

The mixed model equation module 120 of the genetic optimization server 105 inputs the tangible and intangible demographic parameters into the mixed model equation format with each parameter being assigned a weightage (the intangible parameters initially having very low or no weightage) and using the initial measure of efficiency as the result.

The mixed model equation module 120 then solves the mixed model equation for the initial values.

The adjustment module now chooses one or more intangible parameters to increment their weightage in an iterative fashion so that at each iteration the mixed model equation is solved by the mixed model equation module to generate an estimated efficiency and pad placement strategy result.

Some of the intangible parameters will have a perceptible impact on the result and some will not, this is checked by the fitness evaluation module 130, and those intangible parameters having low or no impact on the result are assessed as unfit and removed from the equation to reduce the computational complexity. The impact of the others are evaluated in the iterative process.

The optimized advertisement assessment tool 145 monitors the results of the iterative process and chooses the optimum estimated result for the advertisement and its corresponding placement strategy for implementation.

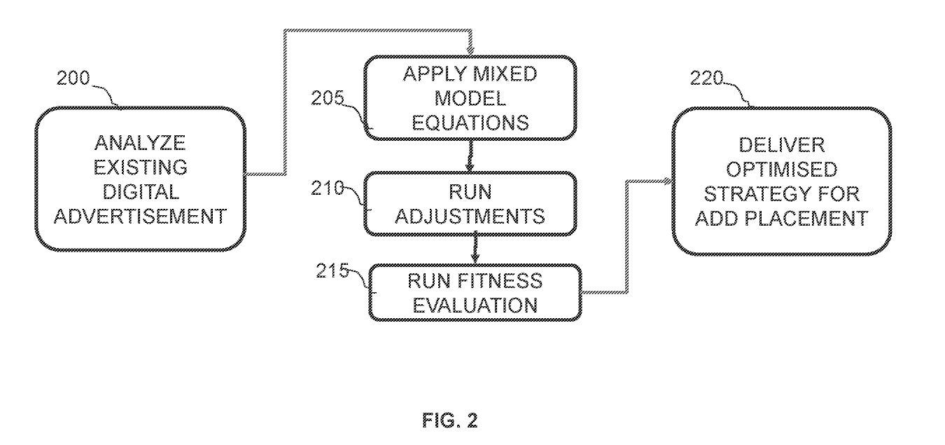

FIG. 2 is an exemplary flow chart of the iterative method for optimizing the impact of the advertisement using available intangible demographic factors including the intangible factors extracted from social media. In FIG. 2, for an initially developed and placed Ad, the Ad efficiency is analyzed using the Advertisement assessment tool 135. Typically this is done by aggregating the impressions, click through rates and the conversion rate of the placed Ad. At step 205, the general mixed model equations are deployed and solved with the best available fitness value/weightage stored for each of the intangible demographic parameters available. The mixed model equation is solved in an iterative fashion by adjusting the weightage assigned to the parameters at step 210. At step 215, the fitness evaluations of each iteration is conducted, thereby providing an estimate of the fitness of the parameter and the efficiency of the Ad and its placement when using these parameters. At step 220, an optimized Ad and a strategy for Ad placement is extracted from the estimated results available by the optimized advertisement assessment tool 145. The optimized Ad and Ad placement is implemented and results of that placement are used as basis for the next cycle of improvement. The optimized fitness values are also stored for the next iterations.

Mathematically an optimization process may be defined as a set of procedures that is systematically used to obtain maximum or minimum of an objective function in finite parameters spaces. Geometrically speaking, an optimization process is defined as a set of procedures that identifies optimized objective function point in finite multi-dimensional spaces. Such optimization is widely used in science, engineering, economics, industry and daily life and it is increased used in advertising. Effectively using limited resources or maximizing profits are typical optimization problems. The practice of optimization depends not only on efficient and robust algorithms but also on modeling techniques. It is an iterative process and one should select different modeling techniques and continuously test and interpret results. It is very hard to reach the real optimum (true) parameters in one shot but procedures should guarantee mathematical convergence, such that each step will result in the objective function moving closer to the optimized point.

As described above, modeling is one of the key aspects for any optimization and it should be dynamically changeable. Clients should be given the freedom to dynamically define models and objective function at run time. The Genetic Optimization Sever (GOS) 105 is provided to deploy general mixed model equations, based on the understanding that objective functions will yield continuous results. In these embodiments, genetic algorithms are used to integrate the intangible demographic parameters, that may change with each Ad and its placement, and can have additional impact on the result of an Ad and its placement, into the optimization process. In such an optimization process, a mixed model equation has to be used in each step of the calculation for continuous optimization of the result.

In mathematical terms, the mixed model equation and its assumptions are listed as follows.

Y=X′b+Z′m+e

### Where:

Y is observation dependent matrix with n rows and m columns
X is relation matrix (n×p) that link fixed β to observations
β is fixed parameter vector with dimension p×1
Z ix relation matrix (n×q) that link random μ to observations
μ is random parameter vector with dimension q×1
e is random error effect with dimension n×1
E(e)=0
var(e)=R, n×n systematic error variance matrix
var (μ)=G, q×q systemic variance—covariance matrix
con(μ,e′)=0

In consideration of the above, the mixed model equation can be written as follows:

$$( \begin{matrix}{X}^{′} {R}^{- 1} X & {X}^{′} {R}^{- 1} Z \\ {Z}^{′} {R}^{- 1} X & {Z}^{′} {R}^{- 1} Z + {G}^{- 1}\end{matrix} ) ( \begin{matrix}β \\ μ\end{matrix} ) = ( \begin{matrix}{X}^{′} {R}^{- 1} Y \\ {Z}^{′} {R}^{- 1} Y\end{matrix} )$$

Further, in consideration of the above, the genetic model may be described as follows:

$$( \begin{matrix}β \\ μ\end{matrix} ) = {( \begin{matrix}{X}^{′} {R}^{- 1} X & {X}^{′} {R}^{- 1} Z \\ {Z}^{′} {R}^{- 1} X & {Z}^{′} {R}^{- 1} Z + {G}^{- 1}\end{matrix} )}^{- 1} \cdot ( \begin{matrix}{X}^{′} {R}^{- 1} Y \\ {Z}^{′} {R}^{- 1} Y\end{matrix} )$$

In order to solve the equation for μ, the result can be substituted into the first equation, as follows:

X′[R⁻¹-R⁻¹Z(Z′R⁻¹Z+G⁻¹)⁻¹Z′R⁻¹]Xb=X′[R⁻¹-R⁻¹Z(Z′R⁻¹Z+G⁻¹)⁻¹Z′R⁻¹]Y

The data modeling formula and parameter estimation equations are listed in [0046] to [0049], wherein paragraph [0047] lists the original equations and [0048] lists the general parameter estimation formula, the actual number of resulting equations is huge and it sometimes presents big challenge to solve equations simultaneously even using the most powerful computers available. The approximate equation in paragraph [0049] is introduced to reduce the number equations tremendously so that the equations can be solved using any high end computer. Since the equation can be further simplified, as follows, by use of a parameter V⁻¹ which consolidates the function in parenthesis [ ] in equation in paragraph [0047], reducing the parameter estimation equation to the form:

V⁻¹=R⁻¹−R⁻¹Z(Z′R⁻¹Z+G⁻¹)⁻¹Z′R⁻¹

X′V⁻¹Xb=X′V⁻¹Y

Where V relates to a Matrix of variance. It should be noted that the parameters estimated from both [0047] and [0049] should be identical even though the matrix dimension in formula [0049] is much smaller.

Furthermore, substantial amounts of ad placement efficiency measurements are being collected continuously for long periods of time. Mathematical models may be built using these datasets, for example, by placing different weights on impressions, clickthroughs and conversion, based on business requirements, to construct objective functions. For example, a sponsor may feel one clickthrough is equivalent to 10 impressions and one conversion is equivalent to 40 impressions. Since V relates to a Matrix of variance, the objective function may be defined as:

Objective function value=impression+10×clickthrough+40×conversions

Ad efficiency is hence a function F[Ad]=Γ{Object Function Value}
Where Γ is the value of the solution of the genetic equation.

When doing mathematical modeling, any or all of the basic factors are used as columns of dependent variables, and use any combination of tangible and intangible demographic factors that form the targeting categories as fixed independent variables. Any continuous fixed effect that impacts the Ad and its placement is introduced into the equation as an independent and random variable relative to Ad quality and the social environment itself. After the mixed model equation is constructed, iterative computation on data is done to find convergence and solve the resulting large matrix equation. This solution when inserted into the Ad efficiency equation in turn provides the currently optimized Ad and placement criteria to maximize the efficiency of the Ad.

Typically, traditional search algorithms for functional optimization use characteristics of the problem to determine the next sampling point gradients, such that these solutions may only be suitable for convex regular functions. If the functions to be optimized are multimodal, discontinuous and/or non-differentiable, additional sampling methods may be needed, such as stochastic sampling methods to determine the next sample points based on stochastic sampling decision rules rather than a set of deterministic decision rules.

This is done by use of the Genetic Algorithms (GA or GAs) that use stochastic search techniques. These genetic algorithms may be used to search the multi-dimensional solution space of a target function through the use of genetic fittest strategy.

The GAs have been increasingly used to solve complicated linear and nonlinear problems by exploring all regions of the state space and exponentially exploiting promising areas through mutation, crossover, and selection operations applied to individuals in the population. These algorithms, in general, first construct a base population of the solution, then maintain and manipulate this population of solutions, construct a fitness function value estimation mechanism, and implement a survival of the fittest strategy in their search for better solutions.

The use of GAs involves the determination of several fundamental issues, including: individual representation that is the values and characteristics of the individuals in the population, a selection function, which provides a consolidation of the characteristics of the focus population, the genetic operators that make up the interrelationship functions, that are inter related secondary functions based on functional relationships between tangible and intangible properties, the creation of the estimation termination criteria as the values of the GA converge, and/or an evaluation function for the Ad efficiency measurement.

Therefore, applying this understanding to the Ads and their placement, the Ads having multiple inter dependent variables comprising intangible and tangible demographic factors that impact their efficiency, can be solved for estimating their effect on the efficiency and effectiveness of the Ad.

In the evaluation, the selection of individuals to produce successive generations of result plays an extremely important role in a genetic algorithm. These selection criteria are generally determined by objective functions. For example, all individuals' fitness values may first be calculated based on business requirements that are established by the advertiser. Subsequently, the individuals with higher fitness values are selected. The total number of individuals selected is also an important factor, since this will affect not only multitude of intangible demographic properties and their frequency, but also the representation of the population that is targeted. For example, if fewer individuals are selected, the frequency of demographic properties will be dramatically changed, which has the risk losing some properties. Another factor that affects the number of individuals selected is the cost associated with individual selection and fitness values calculation. People tend to select more individuals when fitness values are easy and cheap to calculate. Historical data may be used to estimate parameter values and calculate the fitness values based on these solutions for larger number of individuals. In this way, a very high number of individuals need not be chosen with increased cost in the real environment to improve actual results and represent the target population.

Genetic Operators will include cross over and elements, these provide the basic search mechanisms of the GA. The Genetic operators hence will be able to create new inter-related solutions starting from existing solutions. Since the inter-related fitness values estimation are derived, the traditional GA can be expanded to relate the properties of one individual by cross over with any other individual, thereby generating a matrix of 2n(n−1) individuals, and then applying a percentage value to take care of the changes in individuals characteristics over time or mutation to be included in the analysis. These selected set of individuals based on their fitness value can then be re-selected for the next iteration of Ad efficiency to maintain the same or similar management load for next generation real time evaluation.

Moreover, since substantial data for multiple Ad placements can be collected in a database, a subset of individuals that have better fitness performance can be selected as a startup population. Some of the input independent variables that may not have existed in a historic population can also be randomly coded in by choice of corresponding individuals with the specific criteria. A large percentage of the initial population may be purposely randomly constructed to ensure that the pool contains substantially all potential advantageous characteristics. Therefore, it will be possible to extract from a genetic analysis of multiple advertisements that have been run, how to select an optimized advertisement and its placement.

Furthermore, after initialization, the GA may run a search from the selected population of respondents at each iteration, selecting and adding or subtracting from the pool of sample population until a termination criterion for selection is met. A user may optionally specify the maximum number of iterations or other convergence criteria. For example, a mechanism may be deployed to force the entire population to converge into a single solution. Several criteria can be set up to determine whether a genetic algorithm search iteration should be terminated. A first criterion is the absolute rounds of iteration that the GA needs to perform. The GA generally searches until the required round is finished. A second criterion is the variance of fitness values among a selected group. In some cases, iteration may be terminated when the variance is smaller than a threshold. A third criterion is absolute improvement of fitness values from one iteration to the next. In another example, iteration can be terminated if overall improvement is smaller than some arbitrarily acceptable threshold. In practice, one or more of these criteria may be executed, for example, to terminate iteration if one or more of these criteria is met.

In still further embodiments, a fitness evaluation may be executed to determine the inclusion of each individual of the target population selected. For example, individuals with large fitness values are what the user wants to maximize. A mixed model equation is used at this stage to obtain parameter estimations, after which these parameters and characteristics are used to estimate the regression values for impressions, clickthroughs and conversions. The following fitness formula may then be used to calculate fitness values:

Fitness=a′impressions+b′clickthrough+c′conversion

In this way, fitness relates to the efficiency of advertisement.

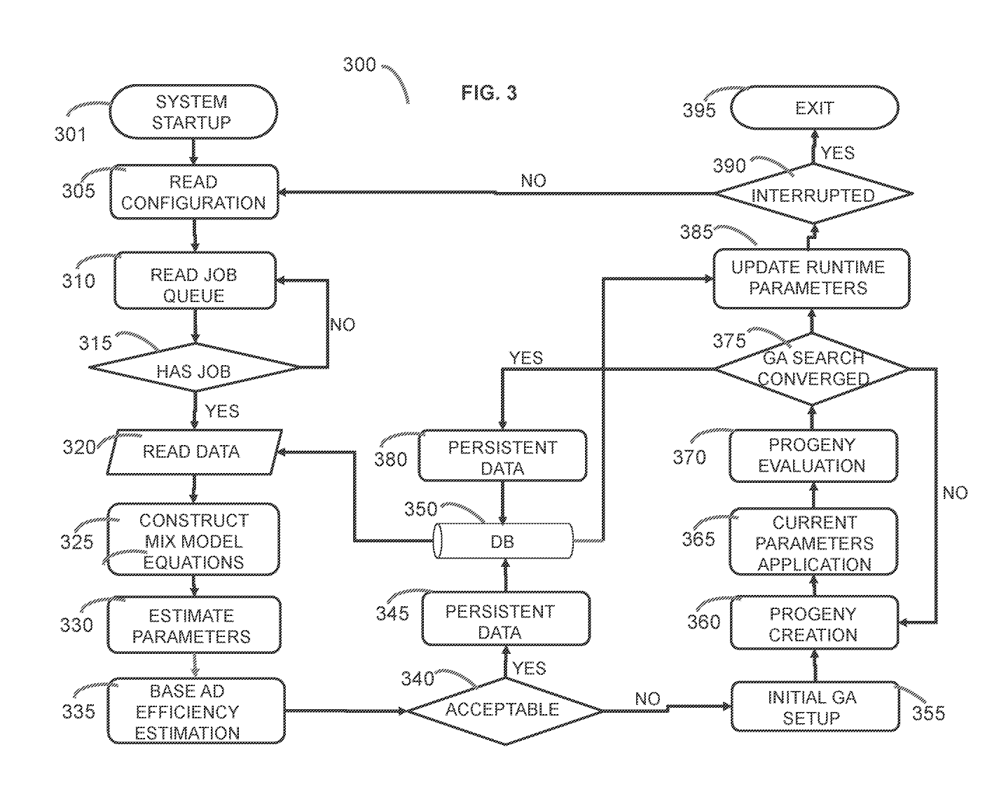

FIG. 3 is a flow chart 300 that shows the introduction of social media measurement of inter-related tangible and intangible demographic parameters into mixed model equations to optimize the Ad and its placement, according to an embodiment of the invention.

The system is started at step 301 and the system configuration data is loaded from a data store to configure the system. The configuration also loads the job queue with the Ads that have been developed for a target audience at his time (step 305).

The job queue is checked and the Ad to be optimized is read into the processing unit for start of optimization (step 310).

If there is no job at step 315, return system returns to step 310 to check for availability of Ads to be optimized.

If there is an Ad in the job queue during the check at step 315, the job data including the information on the initial startup from stored historic data, the data on the sample population chosen, the termination setup and the result analysis criteria for processing the set of Ads are input into the system (step 320).

One or more mixed model equations are constructed from the available data loaded and the Ad characteristics (step 325).

The Ad efficiency estimation the parameters are extracted from the initial data load to enable estimation of Ad efficiency (step 330).

The base Ad efficiency is estimated with the extracted parameters from the initial data loaded (step 335).

Acceptability of the base Ad efficiency estimate is checked (step 340).

If the Base Ad efficiency estimate is acceptable at step 340, then the data from the estimation system is extracted and converted to persistent data (step 345).

The Persistent data so generated is stored with the ad efficiency value and the extracted parameters in a database (step 350).

At step 340, if the base Ad efficiency estimate is not acceptable, then the initial Genetic Algorithm(s) or GA is enabled to evaluate and iterate the mixed model equations (step 355).

The GA is run to identify, and create interrelationships that define new progeny based on tangible and intangible demographic factors within the selected sample population (step 360).

Current efficiency estimation parameters are applied to the new equation (step 365).

The Ad and ad placement efficiency are determined with the effect of progeny included (step 370).

The result is then evaluated (step 375).

If the convergence is successful, then the persistent data is extracted at step 380, and stored in memory at step 350.

If the convergence is not successful, then the progeny creation is re-executed (360). The GA loop is iteratively executed with the new result as base to drive the result towards convergence with the iterative progeny evaluation, and convergence is checked after each iteration till the termination criteria is reached (step 375).

The stored persistent data is used to update the runtime parameters (step 385).

If the runtime parameters are interrupted at any time, before convergence is reached (step 390), the work flow may be ended (step 395).

If the runtime parameters are not interrupted, at step 390, the system configuration may be read again at step 305 and the process repeated with the next Ad in the queue, step 310 on till all Ads in the queue are complete.

Once all Ad fitness values and placement data are collected the best Ad and Ad placement result is executed to collect the efficiency results of the Ad optimization. The process may be repeated with new Ad sets and configuration inputs but previous historic data to further improve the Ad efficiency.

The implementation of this flow chart may be executed by a computer system within which a set of instructions, for causing the system to perform any one or more of the methodologies discussed herein. In alternative embodiments, the computer system operates as a standalone device or may be connected (e.g., networked) to other computer systems. In a networked deployment, the machine may operate in the capacity of a server or a client machine in server-client network environment, or as a peer machine in a peer-to-peer (or distributed) network environment. Further, one or more of the methodologies or functions described herein may be embodied in a computer-readable medium on which is stored one or more sets of instructions (e.g., software). The software may reside, completely or at least partially, within memory and/or within a processor during execution thereof. The software may further be transmitted or received over a network. It should be understood that components described herein include computer hardware and/or executable software code which is stored on a computer-readable medium for execution on appropriate computing hardware.

One or more of the methodologies or functions described herein may be embodied in the computer-readable medium on which is stored one or more sets of instructions (e.g., software). The software may reside, completely or at least partially, within memory and/or within a processor during execution thereof. The software may further be transmitted or received over a network. It should be understood that components described herein include computer hardware and/or executable software code which is stored on a computer-readable medium for execution on appropriate computing hardware.

The terms “computer-readable medium” or “machine readable medium” should be taken to include a single medium or multiple media that store the one or more sets of instructions. The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. The terms “computer-readable medium” or “machine readable medium” shall accordingly be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A system for converting available tangible and intangible parameters into an efficiency and placement strategy of an advertising object, the system comprising:
a processor;
a memory containing machine readable medium comprising machine executable code having stored thereon instructions for operating the system, wherein the processor is coupled to the memory,
the memory further containing available parameters, wherein the available parameters comprise tangible parameters and intangible parameters and wherein the available parameters impact an efficiency of the advertising object and optimum placement of the advertising object;
wherein the system is configured to execute the machine executable code to cause the control system to:
aggregate impressions, clickthrough rates and conversion rates of a placed advertising object to generate an initial result for an ad efficiency;
using the initial result, solve a mixed model equation with the available parameters, each with an assigned weightage, as coefficients in an iterative fashion by adjusting the assigned weightage of the available parameters;
evaluate fitness of each iteration to calculate an estimate of a fitness of each of the available parameters and the improvement in efficiency of the advertising object and its placement when using the available parameters;
optimize the advertising object and a strategy for placement of the advertising object; and
implement the optimized advertising object and placement strategy.

2. The system of claim 1, wherein the intangible parameters are extracted from social media.

3. The system of claim 1, wherein a genetic algorithm is used to optimize the advertising object and the strategy for placement of the advertising object.

4. The system of claim 3, wherein the genetic algorithm runs a search from a selected population of respondents at each iteration, selecting and adding or subtracting from a pool of the population until a termination criterion for selection is met.

5. The system of claim 4, wherein the use of the genetic algorithm comprises determining one or more selected from the group consisting of individual representation in the population, a selection function which provides a consolidation of the characteristics of the focus population, genetic operators that make up interrelationship functions that are interrelated secondary functions based on functional relationships between the parameters, estimation termination criteria as the values of the genetic algorithm converge, and an evaluation function for the advertising object efficiency measurement.

6. The system of claim 1, wherein a plurality of mixed model equations are solved.

7. The system of claim 1, wherein the memory further comprises historic data and wherein the system uses the historic data as a starting point for the available parameters.

8. A computerized method comprising:
aggregating impressions, clickthrough rates and conversion rates of a placed advertising object;
solving a mixed model equation in an iterative fashion by adjusting a weightage assigned to available parameters, wherein the available parameters comprise tangible parameters and intangible parameters;
evaluating fitness of each iteration to calculate an estimate of a fitness of each of the available parameters and efficiency of the advertising object and its placement when using the available parameters;
optimizing an advertising object and a strategy for placement of the advertising object; and
implementing the optimized advertising object and placement strategy.

9. The method of claim 8, further comprising extracting the intangible parameters from social media.

10. The method of claim 8, wherein genetic algorithms are used to optimize the advertising object and the strategy for placement of the advertising object.

11. The method of claim 10, wherein the genetic algorithm runs a search from a selected population of respondents at each iteration, selecting and adding or subtracting from a pool of the population until a termination criterion for selection is met.

12. The method of claim 11, wherein the use of the genetic algorithm comprises determining one or more selected from the group consisting of individual representation in the population, a selection function which provides a consolidation of the characteristics of the focus population, genetic operators that make up interrelationship functions that are interrelated secondary functions based on functional relationships between the parameters, estimation termination criteria as the values of the genetic algorithm converge, and an evaluation function for the advertising object efficiency measurement.

13. The method of claim 8, wherein solving the mixed model equation in an iterative fashion further comprises solving a plurality of mixed model equations.

14. The method of claim 8, further comprising constructing the mixed model equation.

15. The method of claim 8, further comprising using historic data as a starting point for the available parameters.

16. A computerized advertisement optimization system comprising:
a computer server comprising:
an advertisement assessment tool to generate an initial assessment of efficiency of an advertisement;
a mixed model equation module to solve a mixed model equation of the advertisement efficiency and placement strategy using weighted tangible parameters for fixed effects and weighted intangible parameters for random effects and provide an estimate of the advertisement efficiency and ad placement strategy;
an adjustment module to adjust the weightage assigned to at least one chosen parameter from the tangible parameters and intangible parameters, in an iterative fashion to optimize the efficiency and placement strategy; and
a fitness evaluation module to evaluate the fitness of the at least one chosen parameter for iterative adjustment of weightage and change the at least one chosen parameter based on their impact on the result of the solution of the mixed model equation; and
an optimized advertisement assessment tool to check and extract the estimate of result, from the plurality of results of the iterative solution of the mixed model equation, that provide the optimized advertisement and strategy for placement of the advertisement.

17. The system of claim 16, further comprising a data store configured to store information relating to the mixed model equations that contain the experience-based weighted intangible demographic factors.

18. The system of claim 16, further comprising an advertisement assessment tool to assess typical advertisement efficiency of an advertisement without optimization using intangible demographics from social media.

19. The system of claim 16, further comprising an optimized advertisement assessment tool to select a most efficiency strategy for advertisement object placement based on the result of the iterative processing of data through the mixed model equation module with the weightage step adjusted for the intangible demographic parameters at each iteration using the value adjustment module, and the estimates of the fitness of each individual intangible demographic parameter and the efficiency data after each iteration in the evaluation module and extract the optimized advertisement object and placement characteristics from the iterated value.
